(19) United States
(12) Patent Application Publication
(10) Pub. No.: US 2009/0201472 A1
(43) Pub. Date: Aug. 13, 2009

(54) LIQUID IMMERSION EXPOSURE APPARATUS AND METHOD OF LIQUID IMMERSION EXPOSURE

(76) Inventors: Hirokazu KATO, Zushi-Shi (JP); Shinichi Ito, Yokohama-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/366,542

(22) Filed: Feb. 5, 2009

(30) Foreign Application Priority Data
Feb. 7, 2008 (JP) 2008-27641

(51) Int. Cl. G03B 27/52; G03B 27/32

(52) U.S. Cl. 355/30; 355/77

(57) ABSTRACT

A liquid immersion exposure apparatus has a stage on which a substrate to be processed is disposed and that moves based on a position control signal, a projection unit that projects a beam onto the substrate to be processed, a liquid supply unit that supplies liquid between the substrate to be processed and the projection unit, a liquid discharge unit that discharges the liquid held between the substrate to be processed and the projection unit, a gas ejection unit includes a first ejection unit and a second ejection unit disposed so as to surround at least a part of the projection unit and each ejecting gas onto the substrate to be processed, and a control unit that controls an amount of gas flow at the first ejection unit and an amount of the gas flow at the second ejection unit based on a moving speed of the stage while the stage is being moved.

### CROSS REFERENCE TO RELATED APPLICATION

This application is based upon and claims benefit of priority from the Japanese Patent Application No. 2008-27641, filed on Feb. 7, 2008, the entire contents of which are incorporated herein by reference.

### BACKGROUND OF THE INVENTION

1. Field of the Invention

The present invention relates to a liquid immersion exposure apparatus and a method of liquid immersion exposure.

2. Related Art

Along with miniaturization of semiconductor devices, it is required to improve resolution by increasing numerical apertures (NA) (aperture ratio of projector lens) of exposure apparatuses. A technology of the liquid immersion exposure is known in which, since the NA is proportional to a refractive index, a gap between a lens and a wafer is filled with liquid to increase the refractive index in the gap and thereby improve a practical NA.

As means for filling the gap between a projector lens and a wafer (substrate to be processed on a stage) with water, a method called a local fill method is generally used for holding water only near the lens (see, for example, S. Owa, H. Nagasaka, Y. Ishii, O. Hirakawa, T. Yamamoto, Feasibility of immersion lithography, Proceedings of SPIE, 2004, Vol. 5377). However, when the stage is operated at a high speed, the liquid easily leaks outside a liquid immersion head equipped with the projector lens. It is known that the liquid drop which has been left behind on the substrate after the liquid drop has leaked outside the liquid immersion head can cause defects unique to liquid immersion (such as a water mark defect) (see, for example, Michael Kocsis, et al, Immersion Specific Defect Mechanisms: Findings and Recommendations for their Control, Proceedings of SPIE, 2006, Vol. 6154).

In order to improve a performance for holding liquid when the stage is operated at a high speed, a liquid immersion exposure apparatus provided with a gas ejection mechanism (for example, referred to as a gas seal) at a periphery of the liquid immersion head is proved.

The liquid immersion exposure apparatus equipped with such a gas ejection mechanism has a problem in which bubble is caught into the liquid held from a forward side in a direction of relative movement of the liquid immersion head, resulting in decreasing exposure accuracy and causing defects (see, for example, U.S. Patent Application Publication No. 2005/0007569). Such defects are referred to as “bubble defects”.

### SUMMARY OF THE INVENTION

According to one aspect of the present invention, there is provided a liquid immersion exposure apparatus comprising:

a stage on which a substrate to be processed is disposed and that moves based on a position control signal;

a projection unit that projects a beam onto the substrate to be processed;

a liquid supply unit that supplies liquid between the substrate to be processed and the projection unit;

a liquid discharge unit that discharges the liquid held between the substrate to be processed and the projection unit; and

a gas ejection unit that includes a first ejection unit and a second ejection unit disposed so as to surround at least a part of the projection unit and each ejection unit ejecting gas onto the substrate to be processed while the stage is being moved, the gas ejecting unit in which an amount of the gas flow is controlled based on a moving speed of the stage.

According to one aspect of the present invention, there is provided a method of liquid immersion exposure illuminating a mask with an exposure beam, and exposing a substrate disposed on a stage with the exposure beam via liquid filled between a projection unit and the substrate, the method comprising:

ejecting gas to the substrate from a first ejection unit and a second ejection unit disposed so as to surround at least a part of the projection unit; and

adjusting an amount of gas flow each at a first ejection unit and a second ejection unit according to a moving speed of the stage while the stage is being moved.

### BRIEF DESCRIPTION OF THE DRAWINGS

FIG. 1 is a schematic configuration diagram illustrating a liquid immersion exposure apparatus according to the exemplary embodiment of the present invention.

FIG. 2 is a schematic configuration diagram illustrating a gas ejection mechanism.

FIG. 3 is a diagram illustrating a moving direction of a liquid immersion head with respect to a stage.

FIG. 4 is a graph illustrating a transition of a stage speed.

FIG. 5 is a graph illustrating a transition of a stage acceleration.

FIG. 6 is a graph illustrating a transition of an amount of gas flow at each ejection unit.

FIG. 7 is a diagram illustrating a dynamic-forward-contact angle of meniscus.

FIG. 8 is a graph illustrating a transition of an amount of gas flow at each ejection unit.

FIG. 9 is a graph illustrating a transition of an amount of gas flow at each ejection unit.

FIG. 10 is a schematic configuration diagram illustrating the gas ejection mechanism according to an example of modification.

FIG. 11 is a diagram illustrating one example of a schematic configuration of the ejection unit.

FIG. 12 is a graph illustrating the stage speed and the transition of the amount of the gas flow at each ejection unit.

FIG. 13 is a diagram illustrating elimination of residual liquid drops.

FIG. 14 is a graph illustrating the stage speed and the transition of the amount of the gas flow at each ejection unit.

### DESCRIPTION OF THE EMBODIMENTS

Exemplary embodiment of the present invention will be described below with reference to the drawings.

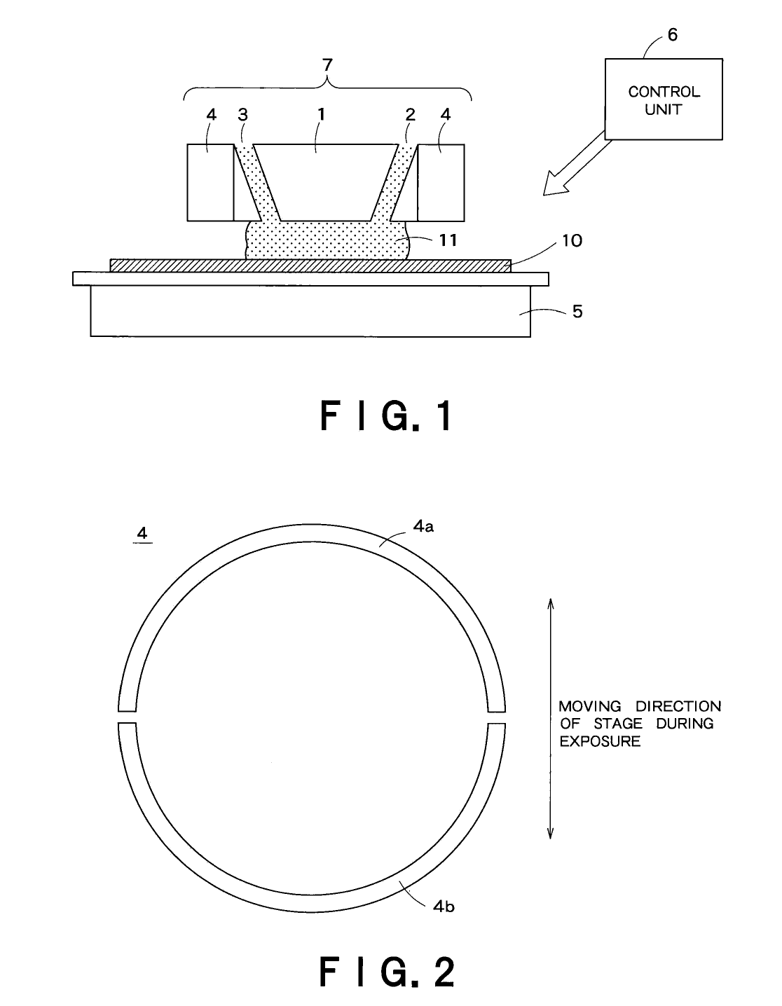

FIG. 1 is a schematic configuration diagram illustrating a liquid immersion exposure apparatus according to the exemplary embodiment of the present invention. The liquid immersion exposure apparatus is provided with a stage 5, a control unit 6 and a liquid immersion head 7. The liquid immersion head 7 includes a projection unit 1, liquid supply unit 2, liquid discharge unit 3 and gas ejection mechanism 4.

A wafer 10 on which exposure processing is performed is held on the stage 5. The liquid supply unit 2 supplies liquid 11 such as water to fill the gap between the projection unit 1 and the wafer 10. The liquid 11 filling the gap between the projection unit 1 and the wafer 10 can be discharged from a liquid discharge unit 3.

The projection unit 1 projects a beam that has passed a mask (not illustrated) onto the wafer 10. The projection unit 1 is, for example, a refraction projector lens.

The stage 5 can move in horizontal and vertical directions based on a position control signal output from the control unit 6 to determine a position of the wafer 10.

The gas ejection mechanism 4 is provided at an outer periphery of the projection unit 1 in such a manner as to surround the projection unit 1. FIG. 2 is a top plan view illustrating the gas ejection mechanism 4. The gas ejection mechanism 4 includes two ejection units 4a and 4b. The ejection units 4a and 4b eject gas such as air. An amount of gas flow ejected from the ejection units 4a and 4b is each controlled by the control unit 6. The ejection units 4a and 4b are shaped in a semicircle ring made by dividing a circle ring into two and symmetrically disposed in a moving direction of the stage during exposure (when projecting a beam).

The control unit 6 controls an output of a position control signal, the amount of gas flow, supplying and discharging the liquid. The control unit 6 further controls the amount of gas flow injected from the ejection units 4a and 4b based on the stage speed.

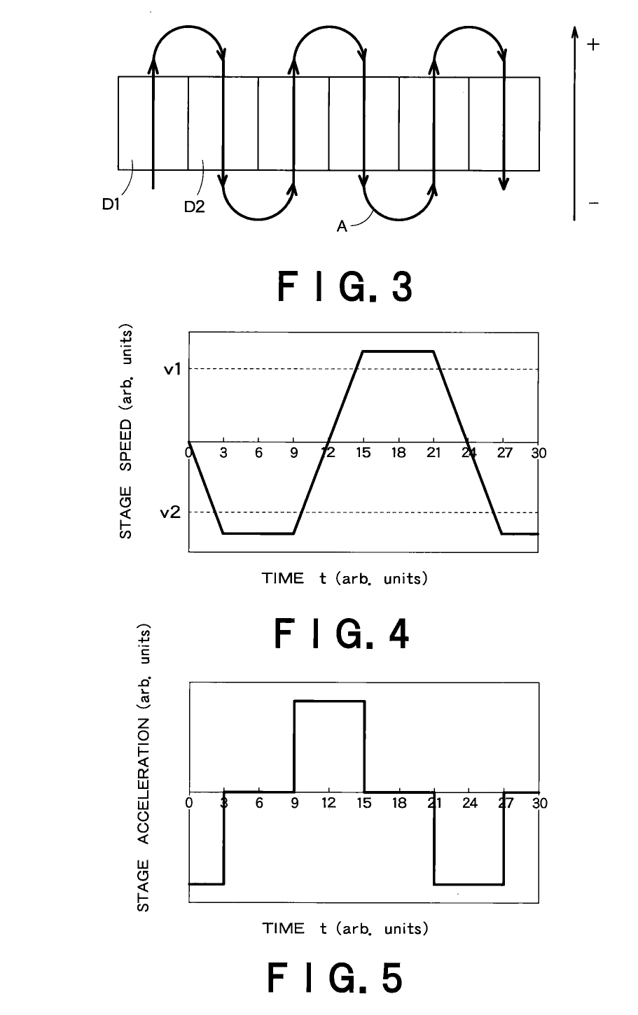

An operation of the stage 5 (scanning exposure operation) will be described using FIG. 3. An arrow “A” illustrated in FIG. 3 indicates a moving direction of the liquid immersion head 7 with respect to the stage 5 viewed from above. After having moved in an upward direction with respect to the stage 5 (die D1) in the figure, the liquid immersion head 7 changes the direction and moves in a downward direction with respect to the stage 5 (die D2) in the figure.

As described above, the liquid immersion head 7 continuously move on a plurality of dies to perform scanning exposure while changing the moving direction from up to down and from down to up in the figure. The direction in which the liquid immersion head 7 moves from down to up with respect to the stage 5 in FIG. 3 is defined as a positive direction for descriptions.

Note that the liquid immersion head 7 is actually fixed and the stage 5 is moved. That is, that the liquid immersion head 7 moves from down to up with respect to the stage 5 in FIG. 3 is equivalent to that the stage 5 actually moves from up to down with respect to the liquid immersion head 7.

FIG. 4 is a graph illustrating a transition of a stage speed when an operation for exposing two adjacent dies is defined as one period of a scanning operation. A time t=0 to 24 corresponds to one period. The stage is moved at a constant speed during exposure, and inverted to move when exposing one die is completed.

The time t=3 to 9 corresponds to an operation of scanning exposure in a positive direction, that is, the operation of scanning exposure of a die D1 illustrated in FIG. 3. The time t=15 to 21 corresponds to an operation of scanning exposure in a negative direction, that is, the operation of scanning exposure of a die D2 illustrated in FIG. 3. The time t=0 to 3, 9 to 15, and 21 to 24 correspond to a returning (turning around) operation. The stage acceleration for each time is as illustrated in FIG. 5.

A speed component in a lateral direction is included when the returning operation, however, which is omitted for convenience of description.

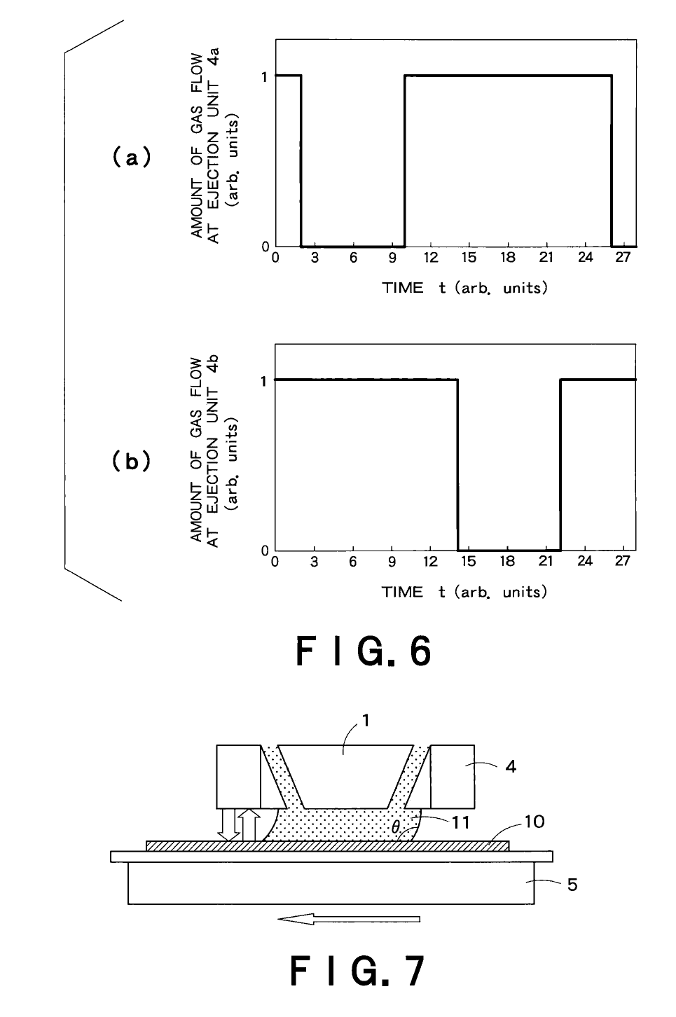

FIG. 6 illustrates the amount of the gas flow at each of ejection units 4a and 4b controlled by the control unit 6. Suppose that the ejection unit 4a is disposed at a side in the positive direction, and the ejection unit 4b is disposed at a side in the negative direction.

The amount of the gas flow is 0 at the ejection unit 4a when the stage speed is a first predetermined speed or less (v2 in FIG. 4) and a constant amount otherwise.

The amount of the gas flow is 0 at the ejection unit 4b when the stage speed is a second predetermined speed or more (v1 in FIG. 4), and a constant amount otherwise. The speed v1 is set to, for example, v1=−v2.

That is, the control unit 6 controls the amount of the gas flow so that it becomes 0 at the ejection unit disposed at a forward side in a moving direction of the liquid immersion head with respect to the stage (wafer) during exposure. In other words, the control unit 6 controls the amount of the gas flow so that it becomes 0 at the ejection unit disposed at an opposite side in a moving direction of the stage during exposure (beam projection).

As described above, the amount of the gas flow is controlled according to the moving speed of the stage so that an increase of a dynamic-forward-contact angle θ of an end portion (meniscus) of the liquid 11 filling the gap between the projection unit 1 and the wafer 10 can be inhibited. It is known that the larger the dynamic-forward-contact angle θ is, the more frequently the bubble defects occur.

The liquid immersion exposure apparatus according to the present invention can inhibit an increase of the dynamic-forward-contact angle and thereby can reduce the number of occurrences of the bubble defects, resulting in increasing performance of the exposure.

In the above embodiment, the stage speeds v1 and v2 are appropriately set according to volatility of the wafer (substrate to be processed), the scanning speed and acceleration of the exposure stage, and shot size.

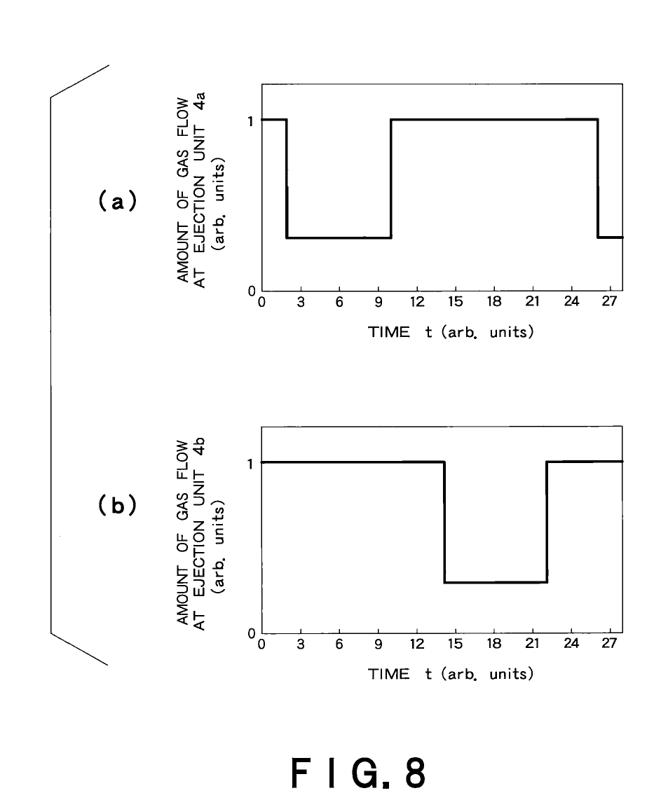

In the above embodiment, as illustrated in FIG. 4 and FIG. 6, when the stage speed becomes v2 or less and when the stage speed becomes v1 or more, the amount of the gas flow at the ejection units 4a and 4b is set to 0 respectively, however, the amount of the gas flow is not necessarily 0 as illustrated in FIG. 8.

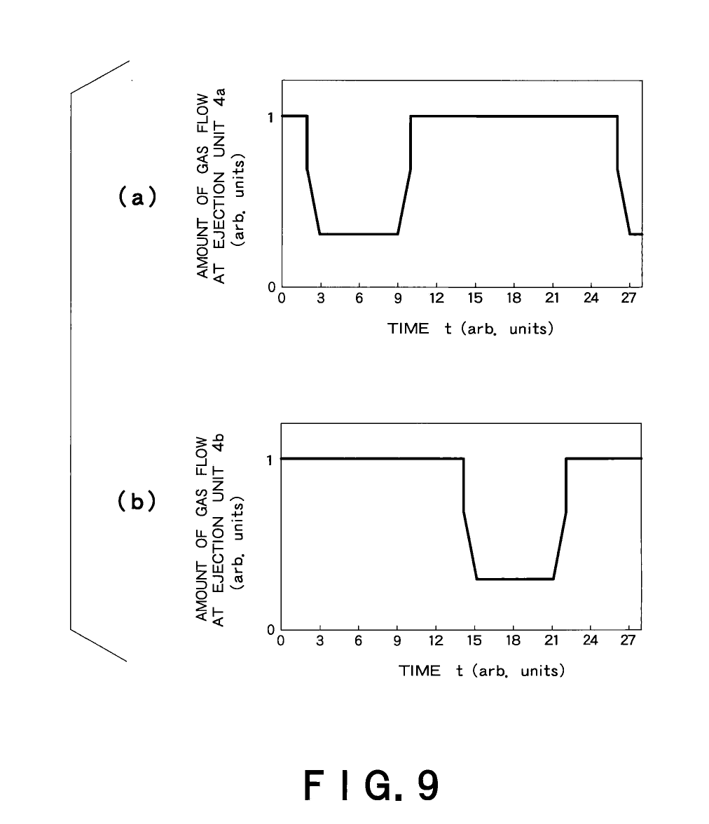

Further, as illustrated in FIG. 9, the amount of the gas flow may be slowly changed. Since, with this slow change, a meniscus state of the liquid filling the gap between the projection unit and the wafer can be inhibited from rapidly changing, the number of the occurrences of the bubble defects can be further decreased.

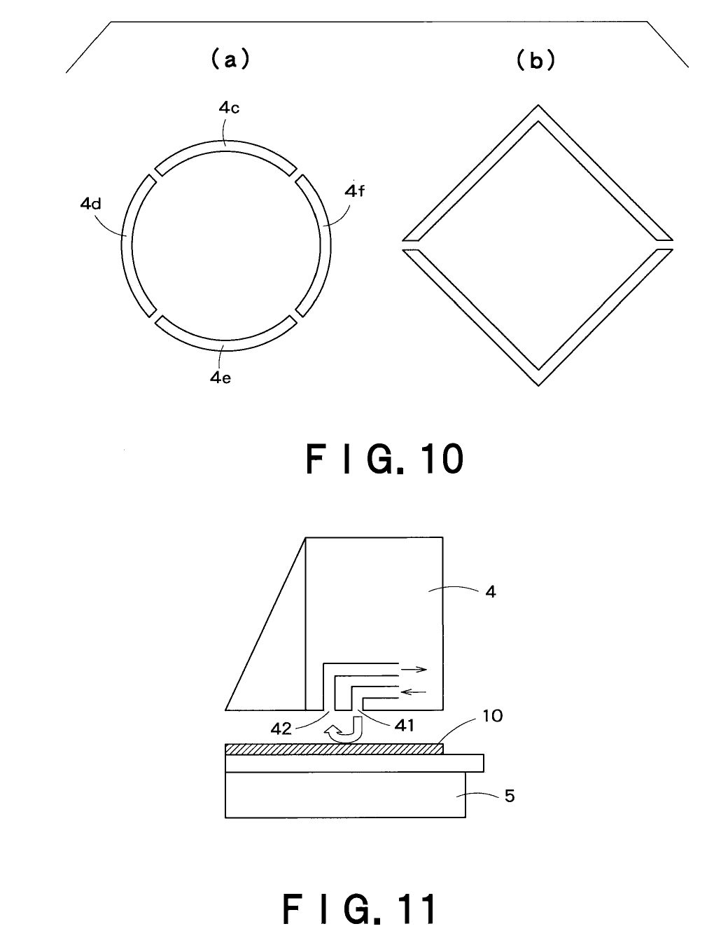

In the embodiment described above, the gas ejection mechanism 4 is structured to include two ejection units 4a and 4b each shaped in a semicircle ring as illustrated in FIG. 2, however, it may be structured to include four ejection units 4c, 4d, 4e, and 4f each shaped in a quarter circular arc as illustrated in FIG. 10(a). The ejection units 4d and 4f are disposed respectively at portions where the ejection units 4c and 4e are rotated by 90 degrees viewed from a center of a circle. At this time, the amount of the gas flow at the ejection units 4c and 4e are controlled similarly to the amount of the gas flow at the ejection units 4a and 4b in the above-described embodiment.

The amount of the gas flow at the ejection units 4d and 4f are set constant regardless of the stage speed. When the liquid can be sufficiently held by a surface tension, the gas may not be injected from the ejection units 4d and 4f. Further, structure of the ejection units 4d and 4f may be omitted. That is, the ejection unit may not be necessarily structured such that the projection unit is surrounded, but may be structured to be installed outside the projection unit.

In addition, as illustrated in FIG. 10(b), the ejection unit may not be a round ring shape, but may be a polygonal line shape made of adjacent two sides of a square.

As for the structure of the ejection unit, a small hole 41 ejecting gas and a small hole 42 inhaling gas are each disposed side by side as illustrated in FIG. 11. Or, a variety of structures can be employed such that an inside and outside positions for ejecting and inhaling are reversed, a shape of the ejection unit is shaped in a slit shape instead of a small hole, the small hole for inhaling gas is omitted and the like.

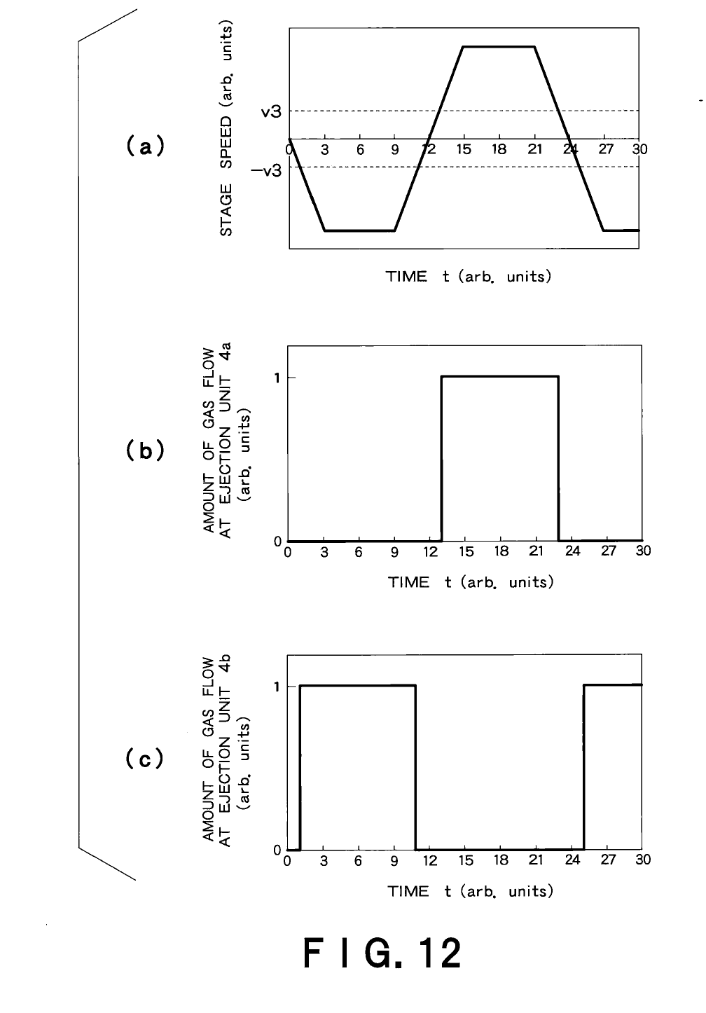

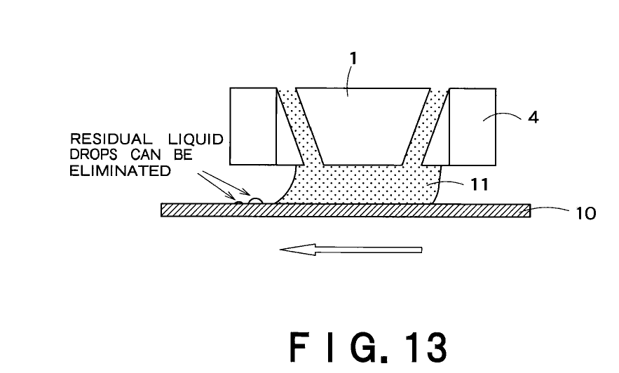

In the embodiment, when the stage speed becomes a predetermined absolute value or more as illustrated in FIG. 6, the amount of the gas flow is controlled to be 0 at the ejection unit disposed at the forward side in the moving direction of the liquid immersion head with respect to the stage (wafer). However, as illustrated in FIG. 12, when the stage speed becomes a predetermined absolute value v3 or more, the gas is controlled to be ejected only at the ejection unit disposed at the backward side in a moving direction of the liquid immersion head with respect to the stage (wafer), and the amount of the gas flow may be controlled to be 0 otherwise.

With this control, since residual liquid drops trapped below the liquid immersion head can be effectively discharged, liquid immersion defects caused by the residual liquid drops can be effectively inhibited from occurring.

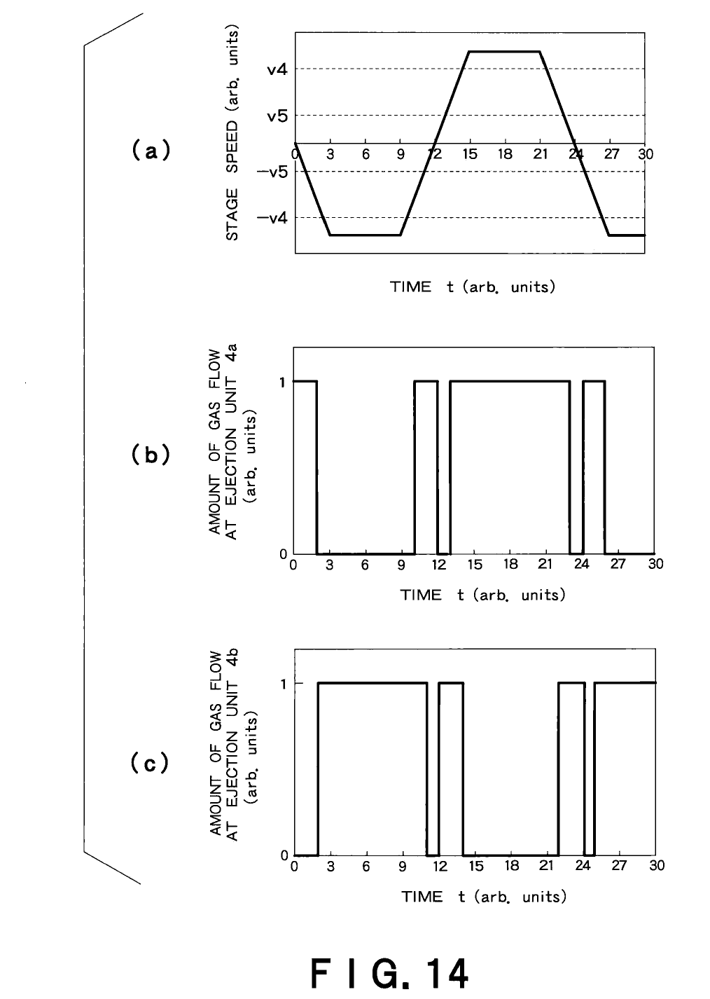

Further, as illustrated in FIG. 14, when the stage speed is a predetermined absolute value v4 or more, the amount of the gas flow at the ejection unit disposed at the forward side in the moving direction of the liquid immersion head with respect to the stage (wafer) is controlled to be 0, and when the stage speed is a predetermined absolute value v5 or less, the amount of the gas flow at the ejection unit disposed at the backward side in a moving direction of the liquid immersion head with respect to the stage (wafer) may be controlled to be 0.

With this control, the liquid immersion defects caused by bubble defects and the residual liquid drops can be effectively inhibited from occurring.

In examples illustrated in FIGS. 12 and 14, the amount of the gas flow may not be decreased to 0, or the amount of the gas flow may be slowly changed.

What is claimed is:

1. A liquid immersion exposure apparatus comprising:
a stage on which a substrate to be processed is disposed and that moves based on a position control signal;
a projection unit that projects a beam onto the substrate to be processed;
a liquid supply unit that supplies liquid between the substrate to be processed and the projection unit;
a liquid discharge unit that discharges the liquid held between the substrate to be processed and the projection unit; and
a gas ejection unit that includes a first ejection unit and a second ejection unit disposed so as to surround at least a part of the projection unit and each ejection unit ejecting gas onto the substrate to be processed while the stage is being moved, the gas ejecting unit in which an amount of the gas flow is controlled based on a moving speed of the stage.

2. The liquid immersion exposure apparatus according to claim 1, further comprising a control unit that controls the amount of the gas flow at the first ejection unit and the amount of the gas flow at the second ejection unit based on the moving speed of the stage while the stage is being moved.

3. The liquid immersion exposure apparatus according to claim 1,
wherein, in a case where a moving direction of the stage is defined as a first direction and a second direction which is an inverted first direction when the beam is being projected onto the substrate to be processed, the first ejection unit is disposed at a side in the first direction and the second ejection unit is disposed at a side in the second direction in the gas ejection unit.

4. The liquid immersion exposure apparatus according to claim 3,
wherein the first ejection unit and the second ejection unit are each shaped in a semi circular ring.

5. The liquid immersion exposure apparatus according to claim 3,
wherein the first ejection unit and the second ejection unit are each shaped in a polygonal line.

6. The liquid immersion exposure apparatus according to claim 3, further comprising:
a third ejection unit provided at a side in a third direction to which the gas ejection unit is rotated by 90 degrees in the first direction; and
a fourth ejection unit provided at a side of a fourth direction to which the third direction is inverted.

7. The liquid immersion exposure apparatus according to claim 6,
wherein the control unit controls the amount of the gas flow at the third ejection unit and the fourth ejection unit to be constant.

8. The liquid immersion exposure apparatus according to claim 6,
wherein the first ejection unit, the second ejection unit, the third ejection unit, and the fourth ejection unit are each shaped in a quarter circular arc.

9. The liquid immersion exposure apparatus according to claim 1,
wherein the first ejection unit and the second ejection unit respectively include a first hole which ejects gas and a second hole which inhales gas.

10. A method of liquid immersion exposure illuminating a mask with an exposure beam, and exposing a substrate disposed on a stage with the exposure beam via liquid filled between a projection unit and the substrate, the method comprising:
ejecting gas to the substrate from a first ejection unit and a second ejection unit disposed so as to surround at least a part of the projection unit; and
adjusting an amount of gas flow each at a first ejection unit and a second ejection unit according to a moving speed of the stage while the stage is being moved.

11. The method of liquid immersion exposure according to claim 10,
wherein, when an operation speed of the stage becomes a predetermined value or more, the amount of the gas flow at the first ejection unit or the second ejection unit disposed at an opposite side in a moving direction of the stage is decreased compared to the amount of the gas flow at the first ejection unit or the second ejection unit when the operation speed of the stage is the predetermined value or less.

12. The method of liquid immersion exposure according to claim 10,
wherein, when an operation speed of the stage becomes a predetermined value or less, the amount of the gas flow at the first ejection unit or the second ejection unit disposed at a side in a moving direction of the stage is decreased compared to the amount of the gas flow at the first ejection unit or the second ejection unit when the operation speed of the stage is the predetermined value or more.

13. The method of liquid immersion exposure according to claim 10,
wherein, when an operation speed of the stage becomes a predetermined value or more, the amount of the gas flow at the first ejection unit or the second ejection unit disposed at a side in a moving direction of the stage is defined as a first amount of flow, and
wherein the amount of the gas flow at the first ejection unit and the second ejection unit when the operation speed of the stage is a predetermined value or less, the amount of the gas flow at the first ejection unit or the second ejection unit disposed at an opposite side in the moving direction of the stage when the operation speed of the stage becomes a predetermined value or more are defined as a second amount of flow that is less than the first amount of the flow.

14. The method of liquid immersion exposure according to claim 13, wherein the second amount of the flow is 0.

15. The method of liquid immersion exposure according to claim 10,
wherein the amount of the gas flow at the first ejection unit or the second ejection unit disposed at an opposite side in a moving direction of the stage when an operation speed of the stage becomes a first predetermined value or more, and the amount of the gas flow at the first ejection unit or the second ejection unit disposed at a side in a moving direction of the stage when an operation speed of the stage is a second predetermined value that is less than the first predetermined value or less are defined as a first amount of the flow, and
wherein the amount of the gas flow at the first ejection unit or the second ejection unit disposed at the opposite side in the moving direction of the stage when an operation speed of the stage becomes less than the first predetermined value, and the amount of the gas flow at the first ejection unit or the second ejection unit disposed at the side in the moving direction of the stage when an operation speed of the stage is more than the second predetermined value are defined as a second amount of the flow that is more than the first amount of the flow.

16. The method of liquid immersion exposure according to claim 15, wherein the first amount of the flow is 0.
